(19) United States
(12) Patent Application Publication
(10) Pub. No.: US 2006/0192114 A1
(43) Pub. Date: Aug. 31, 2006

(54) Processing probe, processing apparatus, and method of manufacturing the processing probe

(76) Inventors: Tatsuya Adachi, Chiba-shi (JP); Takashi Kaito, Chiba-shi (JP)

Correspondence Address: BRUCE L. ADAMS, ESQ., SUITE 1231, 17 BATTERY PLACE, NEW YORK, NY, 10004, US

(21) Appl. No.: 11/346,825

(22) Filed: Feb. 3, 2006

(30) Foreign Application Priority Data
Feb. 10, 2005 (JP) 2005-034731

(51) Int. Cl. G01N 23/00

(52) U.S. Cl. 250/306

(57) ABSTRACT

A method of manufacturing a processing probe comprising a cantilever arranged in opposition to a sample, and a processing needle provided at a tip end of the cantilever to be able to contact with a surface of the sample in a state of being opposed to the sample, the processing needle being sharpened at a tip end thereof, the method comprising a selecting process of selecting a diamond small piece, which is sized to be conformed to a tip end dimension of the cantilever and has a projection, out of a plurality of diamond small pieces, a moving process of moving the selected diamond small piece onto a processing base after the selecting process, and a processing process of performing an etching processing in a manner to further sharpen the projection in an optional shape with focused beam after the moving process and mounting a base end side of the projection to the tip end of the cantilever with the use of the focused beam to fabricate a processing needle.

### BACKGROUND OF THE INVENTION

The present invention relates to a processing probe capable of cutting a sample with the use of a processing needle provided at a tip end of a cantilever to perform fine processing of a surface of the sample into an optional shape in nanometer scale, a processing apparatus having the processing probe, and a method of manufacturing the processing probe.

Conventionally, in order to correctly perform machining in a fine nanometer scale of at most 0.1 μm when machining such as cutting, grinding, etc. is performed, various studies, etc. have been made and it is considered in one of the studies to make use of a scanning probe microscope (SPM) (see Non-Patent Document 1).

Also, there has already been known effectiveness in mounting a cantilever, which has a diamond abrasive grain at a tip end thereof, on an apparatus having the same mechanism as an atomic force microscope (AFM), which is one of the scanning probe microscopes, and using the cantilever to process a sample or the like in nanometer scale of 1 to 100 nm (see Non-Patent Document 2). That is by making use of a diamond abrasive grain, of which particle size is in the order of about 50 μm, as a cutting blade, it is possible to surely cut a sample due to the hardness of the grain to realize a processing in nanometer scale.

[Patent Document 1] JP-T-10-506457

[Non-Patent Document 1] Seizo Morita, “Scanning Probe Microscope (Fundamentals and Future prediction)”, Maruzen, published on Feb. 10, 2000, page 82 (fabrication of various probes), page 124 (fine processing by SPM)

[Non-Patent Document 2] Kiwamu Ashida, other 2, “Study of Ultra Micro-Machining Making Use of Frictional Force Microscope Mechanism”, Papers of Japanese Mechanical Society (C edition), Vol. 64, No. 626 (1998-10), pages 4072-4085

However, the conventional methods described above leave the following problems.

That is, as described in Non-Patent Document 2, the conventional diamond abrasive grain (processing needle) making a cutting blade is beforehand put in a crushed state and adjusted in particle size by the crush. Then a diamond abrasive grain having an optimum shape for a cutting-blade is selected from a plurality of diamond abrasive grains and the diamond abrasive grain is mounted to a tip end of a cantilever. However, it is difficult to select a particular position for a cutting blade at the time of bonding of the diamond abrasive grain. Therefore, a shape of that portion, which contacts as a cutting blade with a sample surface (a surface of a material being cut) , becomes consequently irregular every solid. That is, it is almost impossible to manufacture a plurality of, or a certain amount of products having the same shape (quality). Accordingly, the products become different from one another in processing accuracy and cannot be maintained in quality, so that it is difficult to bring the processing technique in nanometer scale to a practical level.

The invention has been thought of in view of the situation and its object relates to a processing probe having a processing needle of a predetermined shape at a tip end thereof and capable of maintaining a fixed quality at all times, a processing apparatus having the processing probe, and a method of manufacturing the processing probe.

### SUMMARY OF THE INVENTION

In order to solve the problem, the invention provides the following means.

A processing probe of the invention is one comprising a cantilever arranged in opposition to a sample, and a processing needle provided at a tip end of the cantilever to be able to contact with a surface of the sample in a state of being opposed to the sample, the processing needle being sharpened at a tip end thereof, and wherein the processing needle is formed from a diamond small piece into an optional shape by means of focused beam.

Also, a method of manufacturing a processing probe, according to the invention, is a method of manufacturing a processing probe comprising acantilever arranged in opposition to a sample, and a processing needle provided at a tip end of the cantilever to be able to contact with a surface of the sample in a state of being opposed to the sample, the processing needle being sharpened at a tip end thereof, the method comprising a selecting process of selecting a diamond small piece, which is sized to be conformed to a tip end dimension of the cantilever and has a projection, out of a plurality of diamond small pieces, a moving process of moving the selected diamond small piece onto a processing base after the selecting process, and a processing process of performing an etching processing in a manner to sharpen the projection of the diamond small piece in an optional shape with focused beam after the moving process and mounting a base end side of the projection to the tip end of the cantilever with the use of focused beam to fabricate the processing needle.

In the processing probe and the method of manufacturing a processing probe, according to the invention, a plurality of diamond small pieces (for.example, commercial available diamond abrasive grains) are first observed, and a selecting process of selecting an optimum diamond small piece, which makes a processing needle, from the diamond small pieces is performed. That is, a diamond small piece sized (for example, a particle size in the order of 20 μm) to be conformed to a tip end dimension of the cantilever and having a projection on a part thereof is selected. In addition, at this time, the sharper a projection is selected, the shorter a succeeding processing time can be made.

After a diamond small piece is selected, a moving process of picking up the diamond small piece onto the processing base of a focused beam apparatus is performed.

Then, the etching processing is performed by irradiating a focused beam such as a focused ion beam (FIB), etc. on the diamond small piece placed on the processing base to sharpen the projection further. At this time, the processing is performed in a manner to provide for an optional shape, for example, a shape of a single edge, a double edge, a trigonal pyramid, etc. Also, the processing process is performed at the same time so that the base end side of the projection is etched to make a flat surface and the flat surface is mounted to the tip end of the cantilever. Through the processing process, the processing needle, a tip end of which is sharpened, can be mounted to the tip end of the cantilever. In particular, since an optimum diamond small piece suited to a needle tip is selected in the selecting process, many regions are not processed in the processing process but regions being processed can be restricted to the utmost. Therefore, it is possible to shorten a processing time and to lessen a manufacturing cost.

In this manner, since the processing needle is formed into an optional shape by a focused beam, the processing probe thus manufactured always has the same predetermined shape unlike conventional ones. Therefore, it is possible to always keep the same quality. As a result, a sample is enhanced in processing accuracy and fine processing in nanometer scale can be performed with high-accuracy.

Also, since the processing needle can be formed into an optional shape, it is possible to process a sample having a vertical wall, an overhang, or the like, which is conventionally difficult to process, and thus it is possible to heighten freedom in design and to perform a further accurate processing.

Also, the processing probe according to the invention has a feature in that the processing needle in the processing probe according to the invention is etched in a crystal orientation of diamond.

Also, the method of manufacturing a processing probe, according to the invention has a feature in that the etching processing in the method of manufacturing a processing probe, according to the invention, is performed in a crystal orientation of diamond in the processing process.

In the processing probe and the method of manufacturing a processing probe, according to the invention, the processing needle is etched in a crystal orientation of diamond, so that it is possible to obtain a processing needle along an abrasion proof direction. Therefore, the life of the processing probe is extended, and it is possible to achieve an improvement in reliability and processing accuracy.

Also, the method of manufacturing a processing probe, according to the invention, has a feature in that used as the diamond small piece in the method of manufacturing a processing probe, according to the invention, is one, on a ground surface of which a crystal orientation of diamond can be beforehand observed.

In the method of manufacturing a processing probe, according to the invention, used as the diamond small piece is one, on a ground surface of which a crystal orientation of diamond can be beforehand observed, for example, used is a diamond dresser or the like, so that it is possible to shorten time taken in the processing process and to lessen a manufacturing cost.

Also, the processing probe according to the invention has a feature in that the processing needle in the processing probe according to the invention possesses electroconductivity.

Also, the method of manufacturing a processing probe, according to the invention, has a feature in that the method of manufacturing a processing probe, according to any one of the inventions further comprises a doping process of doping impurities in the diamond small piece after the moving process.

In the method of manufacturing a processing probe, according to the invention, since a doping process of doping p-type or n-type impurities in the diamond small piece by means of the ion implantation method, the diffusion method, or the like is performed, electroconductivity can be possessed as with Sic abrasive grains even when a diamond abrasive grain composed of a natural diamond is used as a diamond small piece.

Thereby, there comes out a state, in which electric charge caused by friction with a sample does not accumulate in the processing needle and processing chips (cutting tips, etc.) become hard to adhere, when the sample is subjected to fine processing. Therefore, it is possible to perform fine processing of the sample without the influences of processing chips, etc. to achieve an improvement in quality and accuracy. Also, processing of an insulator sample is made easy.

Also, the method of manufacturing a processing probe, according to the invention, has a feature in that the diamond small piece possesses electroconductivity in the method of manufacturing a processing probe, according to any one of the inventions.

Also, the method of manufacturing a processing probe, according to the invention, has a feature in that the diamond small piece in the processing probe according to the invention is a small piece of dopant containing synthetic diamond.

In the method of manufacturing a processing probe, according to the invention, since a substance (for example, a small piece of dopant containing synthetic diamond) beforehand possessing electroconductivity is used as the diamond small piece, there comes out a state, in which electric charge caused by friction with a sample does not accumulate in the processing needle and processing chips (cutting tips, etc.) become hard to adhere, when the sample is subjected to fine processing. Therefore, it is possible to perform fine processing of the sample without the influences of processing chips to achieve an improvement in quality and accuracy. Also, processing of an insulator sample is made easy.

Also, the processing apparatus according to the invention has a feature in comprising the processing probe according to anyone of the inventions, a stage, on which the sample is placed, moving means that relatively moves the stage and the processing probe in XY directions in parallel to a surface of the sample and in a Z direction perpendicular to to the surface of the sample, and observation means that observes the surface of the sample.

In the processing apparatus according to the invention, by actuating the moving means at an appropriate time, it is possible to bring the processing needle and a surface of the sample into contact with each other and to cut, grind, or the like the surface of the sample into an optional shape to surely perform fine processing. Also, since the observation means is used to enable observing a state of processing of the surface of the sample, it is possible to achieve an improvement in processing accuracy. In particular, since the processing probe, which is formed into an optional shape and is stable in quality, is made use of, fine processing of a sample in nanometer scale can be.performed with high accuracy.

In the processing probe and the method of manufacturing a processing probe, according to the invention, since the processing needle is formed into an optional shape by a focused beam, the same quality is provided at all times with the result that a sample is enhanced in processing accuracy and fine processing in nanometer scale can be performed with high accuracy. Also, since the processing needle is formed into an optional shape, it is possible to process a sample having a vertical wall, an overhang, or the like, which is conventionally difficult to process, and it is possible to heighten freedom in design and to perform a further accurate processing.

Also, with the processing apparatus according to the invention, since the processing probe, which is formed into an optional shape and is stable in quality, is made use of, fine processing of a sample in nanometer scale can be performed with high accuracy.

### BRIEF DESCRIPTION OF THE DRAWINGS

FIG. 1 is a view showing the construction of an embodiment of an processing apparatus according to the invention.

FIG. 2 is a side view showing a processing probe, according to the invention, provided in the processing apparatus shown in FIG. 1.

FIG. 3 is a process drawing illustrating a method of manufacturing the processing probe shown in FIG. 2, and showing a state, in which a plurality of diamond abrasive grains are observed.

FIG. 4 is a process drawing illustrating a method of manufacturing the processing probe shown in FIG. 2, and showing a diamond abrasive grain suited to a needle tip, among the plurality of diamond abrasive grains shown in FIG. 3.

FIG. 5 is a process drawing illustrating a method of manufacturing the processing probe shown in FIG. 2, and a side view showing a state, in which a diamond abrasive grain suited to a needle tip and shown in FIG. 4 is picked up to be placed on a processing base and FIB is irradiated on the diamond abrasive grain to etch the same into an optional shape.

FIG. 6 is a process drawing illustrating a method of manufacturing the processing probe shown in FIG. 2, and a front view showing a state, in which a projection of a diamond abrasive grain is sharpened into an optional shape by means of FIB shown in FIG. 5 and a base end side of the projection is processed to be made a flat surface.

[Description of Reference Numerals and Signs]
D′: diamond abrasive grain (diamond small piece)
S: sample
T: processing base
1: processing apparatus
2: processing probe
3: stage
4: moving means
5: observation means
10: cantilever
11: processing needle

### DETAILED DESCRIPTION OF THE INVENTION

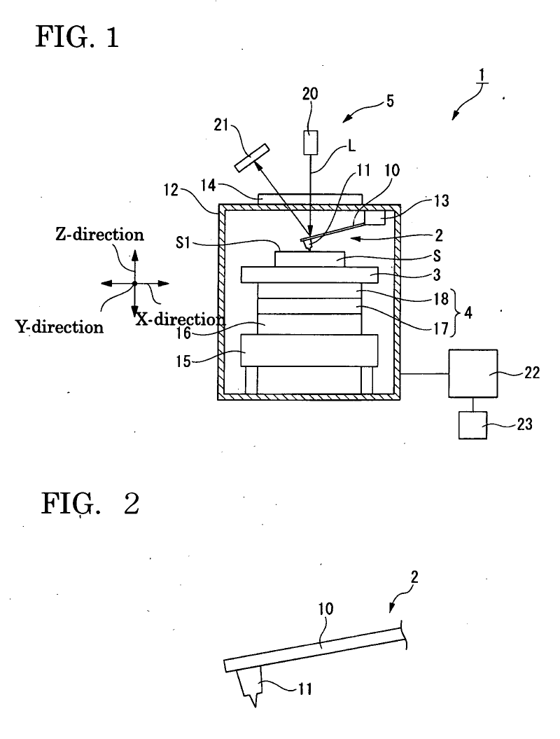

An embodiment of a processing probe, a processing apparatus having the processing probe, and a method of manufacturing a processing probe, according to the invention will be described below with reference to FIGS. 1 to 6.

The processing apparatus 1 according to the embodiment comprises, as shown in FIG. 1, a processing probe 2 arranged (arranged in an upper portion) in opposition to a sample S, a stage 3, on which the sample S is placed, moving means 4 that relatively moves the stage 3 and the processing probe 2 in XY directions inparallel to a sample surface S1 and in a Z direction perpendicular to the sample surface S1, and observation means 5 that observes the sample surface S1.

The processing probe 2 comprises, as shown in FIG. 2, a cantilever 10, and a processing needle 11 provided at a tip end of the cantilever 10 to be opposed to the sample S and contactable with the sample surface S1, the processing needle being sharpened at a tip end thereof. The processing needle 11 is formed from a diamond abrasive grain (diamond small piece) D, which is obtained by crushing natural diamond, into an optional shape by means of focused ion beam (FIB) (focused beam). A method of manufacturing the processing probe 2 will be described below in detail.

The processing probe 2 is detachably fixed to a stationary holder 13 fixed to an upper portion of a casing 12 made of a metallic material or the like. Also, an opening is formed on the upper portion of the casing 12 and a window 14 is mounted in a manner to close the opening.

Also, a base 15 including a vibration proof mechanism is placed on a bottom in the casing 12. A rough movement mechanism 16 such as a stepping motor, etc. is mounted to the base 15 to roughly move the sample S in three XYZ directions. A Z scanner 17 capable of relative movement of the stage 3 and the processing probe 2 in XZ directions, and a XY scanner 18 capable of relative movement of the stage 3 and the processing probe 2 in the XY directions, are placed in this order on the rough movement mechanism 16 and the sample S is placed on the XY scanner 18 with the stage 3 therebetween.

The XY scanner 18 and the Z scanner 17 comprise a piezo-electric element made of PZT (lead zirconate titanate) or the like, and cause fine movements of the stage 3 in the XYZ directions according to an applied voltage, polarity, or the like when voltage is applied thereto. That is, the XY scanner 18 and the Z scanner 17 form the moving means 4. The sample surface S1 can be cut and ground for fine processing with the processing needle 11 by actuating the moving means 4.

Also, the observation means 5 comprises a laser light source 20 that irradiates a laser light L on a reflection surface (not shown) formed on a back surface of the processing needle 11, and a photodiode 21 that detects the laser light L (reflected light) reflected by the reflection surface. The laser light source 20 and the photodiode 21 are arranged outside the casing 12 and above the window 14, so that the laser light L is incident and outgoes through the window 14.

Also, the photodiode 21 measures a state of flexure of the cantilever 10 according to a position, in which the laser light L (reflected light) is incident. That is, the state of flexure of the cantilever 10 is measured by the optical lever system. Also, this measurement is made while performing scanning in the XY directions in a state, in which the moving means 4 applies a minute force to bring the processing needle 11 and the sample surface S1 into contact with each other.

Also, the photodiode 21 outputs results of detection as a DIF signal, and the DIF signal is amplified by a preamplifier or the like and converted into direct current to be fed to a Z voltage feedback circuit of a personal computer (PC) 22 that controls respective constituent parts in an integrated manner. Based on the DIF signal thus fed, the Z voltage feedback circuit applies voltage to the Z scanner 17 to cause fine movement of the sample S in the Z direction. Also, based on the DIF signal thus fed, the PC 22 observes a concave-convex shape of the sample surface S1 or the like and displays an observed image on a display unit 23.

In addition, in measuring the state of flexure of the cantilever 10, it is also possible to use a self-detection type cantilever, which builds in the cantilever 10 a strain gauge capable of detection of displacement, in addition to the optical lever system described above. The embodiment is described with respect to the case where the optical lever system is used.

Subsequently, an explanation is given to a method of manufacturing the processing probe 2.

The method of manufacturing the processing probe 2, according to the embodiment, comprises a selecting process of selecting a diamond abrasive grain D′, which is sized to be conformed to a tip end dimension of the cantilever 10 and has a substantially acute angled projection D1, out of a plurality of diamond abrasive grains D, a moving process of moving the selected diamond abrasive grain D′ onto a processing base T after the selecting process, and a processing process of performing an etching processing in a manner to sharpen the projection D1 of the diamond abrasive grain D′ in an optional shape with FIB after the moving process and mounting a base end side of the projection D1 to the tip end of the cantilever 10 with the use of FIB to fabricate the processing needle 11. The respective processes will be described below in detail.

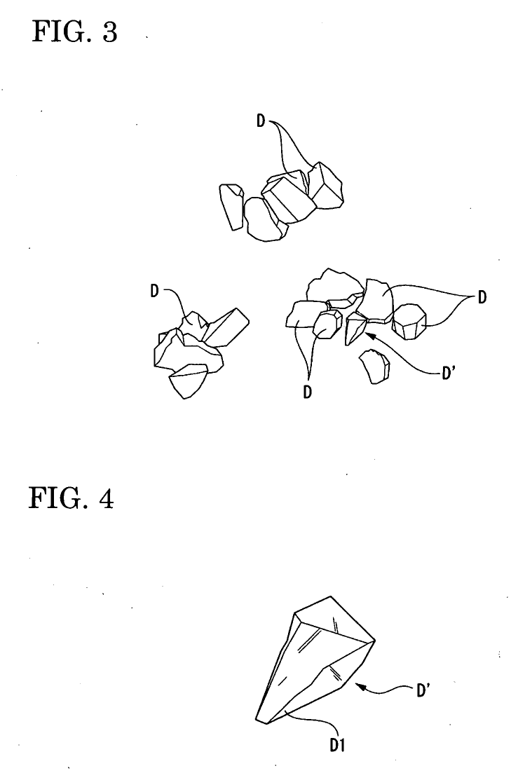

First, as shown in FIG. 3, the selecting process is performed, in which, for example, a scanning ion microscope (SIM) with a FIB device is used to observe the plurality of diamond abrasive grains D and an optimum diamond abrasive grain D′ making a needle tip is selected-therefrom. That is, that diamond abrasive grain D′, which is sized (for example, a particle size of 20 μm) to be conformed to a tip end dimension of the cantilever 10 and a part of which forms a substantially acute angled projection D1 as shown in FIG. 4, is selected.

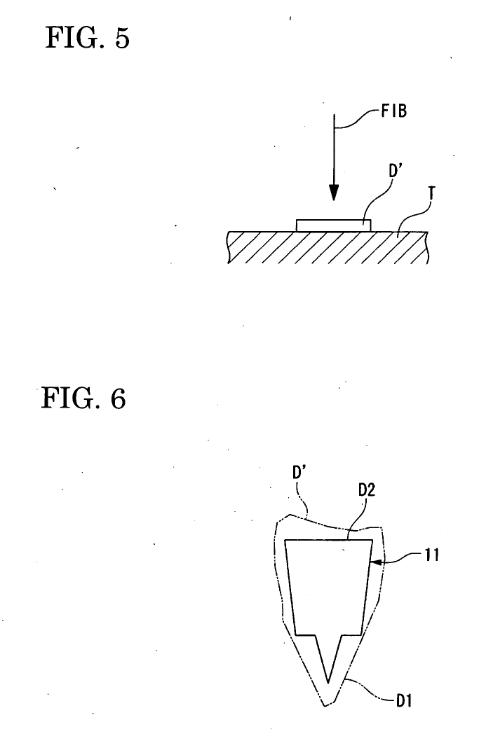

After the diamond abrasive grain D′ is selected through the selecting process, a grasping-mechanism (not-shown) such as a manipulator, etc. is used to pick up the diamond abrasive grain D′ while making confirmation with SIM, and the diamond abrasive grain D′ thus picked up is placed on the processing base T as shown in FIG. 5.

Then, the etching processing is performed by irradiating FIB on the diamond abrasive grain D′ placed on the processing base T to sharpen the projection D1 further as shown in FIG. 6. At this time, the processing is performed in a manner to provide for an optional shape, for example, a shape of a single edge, a double edge, a trigonal pyramid, etc. Also, the processing process is performed at the same time so that the base end side of the projection D1 is etched to make a flat surface D2 and mounted to the tip end of the cantilever 10.

Through the processing process, the processing needle 11, a tip end of which is sharpened, can be mounted to the tip end of the cantilever 10 as shown in FIG. 2. In particular, since an optimum diamond abrasive grain D′ suited to a needle tip is selected from a plurality of diamond abrasive grains D in the selecting process, many regions are not processed in the processing process but regions being processed can be restricted to the utmost. Therefore, it is possible to shorten a processing time and to lessen a manufacturing cost.

In addition, the processing time taken for the etching processing can be further restricted by selecting as a sharp projection D1 as possible when the diamond abrasive grain D′ is selected.

Subsequently, an explanation is given to the case where the processing probe 2 and the processing apparatus 1 are used to perform fine processing of the sample S.

First, after the processing probe 2 is fixed to the stationary holder 13 and the sample S is placed on the stage 3, an initial process is performed, in which the sample surface S1 and the processing needle 11 are brought into contact with each other. That is, the rough movement mechanism 16 is used to move the stage 3 slowly in the Z direction. Also, at this time, the laser light source 20 irradiates a laser light L and the photodiode 21 detects the reflected light. When the rough movement mechanism 16 moves in this state to bring the stage 3 and the processing needle 11 into contact with each other, the processing needle 11 is pushed by the sample S, so that the cantilever 10 flexes a little. Thereby, the laser light L reflected by the reflection surface is varied in angle and a position, in which the laser light L incident on the photodiode 21 is incident, is varied. Thereby, it is possible to surely judge that the sample surface S1 and the processing needle 11 are brought into contact with each other.

After the termination of the initial setting, the XY scanner 18 scans the sample S in the XY directions and the processing needle 11 is moved to a position, in which fine processing is performed. When the processing needle 11 reaches a position, in which the processing is started, the Z scanner 17 causes the stage 3 to make fine movement in the Z direction to bring the processing needle 11 and the sample surface S1 into contact with each other at a predetermined contact pressure. At this time, since the laser light L incident on the photodiode 21 is varied in a position of incidence according to the contact pressure, the processing needle 11 and the sample surface S1 can be brought into contact with each other at the predetermined contact pressure by detecting the position of incidence.

After the processing needle 11 and the sample surface S1 are brought into contact with each other at the predetermined contact pressure, the XY scanner 18 is caused to scan the stage 3 in the XY directions while the state is maintained. Thereby, the processing needle 11 cuts and grinds the sample surface S1 to enable fine processing of the sample surface S1 in nanometer. Fine processing of the sample surface S1 in a predetermined shape can be surely made by, for example, repeating the scanning in all the processing regions.

In addition, a constant contact pressure can be maintained by feedback control of the Z scanner 17 so that the cantilever 10 is made constant in flexure.

In particular, since the processing needle 11 is formed into an optional shape by FIB, it always has the same predetermined shape unlike conventional ones. Therefore, it is possible to always keep the same quality. As a result, the sample S is enhanced in processing accuracy and fine processing in nanometer scale can be performed with high accuracy. Also, since the processing needle 11 can be formed into an optional shape, it is possible to process the sample S having a vertical wall, an overhang, or the like, which is conventionally difficult to process, and thus it ispossible to heighten freedom in design. Also, since the processing needle 11 is formed from the diamond abrasive grain D′, which is a natural diamond, it is possible to ensure hardness to surely perform fine processing of the sample S.

Also, after the termination of fine processing of the sample S, the observation means 5 is used to enable observing .a state (concave-convex shape) of processing of the sample surface S1, so that it is possible to maintain a sure processing accuracy.

In addition, the technical scope of the invention is not limited to the embodiment described above but susceptible to various modifications within a scope not departing from the gist of the invention.

For example, according to the embodiment, the diamond abrasive grain D′ is simply etched with FIB in the processing process but it does not matter if the diamond abrasive grain D′ is etched in a crystal orientation of diamond. By doing this, it is possible to obtain the processing needle 11 along an abrasion proof direction to extend the life of the processing probe 2 and to extend the processing accuracy further.

Also, in this case, instead of using the diamond abrasive grain D′ as a diamond small piece, it is preferable to use a product, such as diamond dresser, etc., which enables beforehand observing a crystal orientation of diamond on a ground surface. When a diamond dresser is used, it is possible to readily confirm the crystal orientation, to shorten time taken for the processing process, and to achieve reduction in manufacturing cost.

Also, it does not matter if a doping process of doping impurities in the diamond abrasive grain D′ is performed after the moving process in the embodiment.

In this case, since p-type or n-type impurities are doped in the diamond abrasive grain D′ by means of the ion implantation method, the diffusion method, or the like, electroconductivity can be possessed as with Sic abrasive grains even when the diamond abrasive grain D′ composed of a natural diamond is used.

In addition, it does not matter if a diamond abrasive grain D′ (for example, a small piece of dopant containing synthetic diamond) beforehand possessing electroconductivity is used.

In this manner, by providing for electroconductivity, there comes out a state, in which electric charge caused by friction with the sample S does not accumulate in the processing needle 11 and processing chips (cutting tips, etc.) become hard to adhere, when the sample S is subjected to fine processing. Therefore, it is possible to perform fine processing of the sample S without the influences of processing chips, etc. to achieve an improvement in quality and accuracy. Also, processing of an insulator sample is made easy.

Also, while the diamond abrasive grain D′ is adopted as a diamond small piece in the embodiment, it is not limited thereto but it does not matter if a diamond dresser is adopted as described above, or Sic abrasive grains and synthetic diamond abrasive grains are adopted. However, it is preferable to adopt a diamond abrasive grain composed of a natural diamond in terms of hardness.

Also, while according to the embodiment, the diamond abrasive grain D′ is simply etched with FIB in the processing process, FIB is not limitative but it does not matter if focused beam is used. For example, laser beam or gas (for example, water vapor)-assisted electron beam will do.

In this manner, a method of selecting and implanting an abrasive grain is not limited to diamond abrasive grains but applicable to various kinds of fine powder.

What is claimed is:

1. A processing probe comprising:
a cantilever arranged in opposition to a sample; and
a processing needle provided at a tip end of the cantilever to be able to contact with a surface of the sample in a state of being opposed to the sample, the processing needle being sharpened at a tip end thereof, and being formed from a diamond small piece into an optional shape by means of focused beam.

2. The processing probe according to claim 1, wherein the processing needle is etched in a crystal orientation of diamond.

3. The processing probe according to claim 1, wherein the processing needle possesses electroconductivity.

4. A processing apparatus comprising:
the processing probe according to claims 1;
a stage, on which the sample is placed;
moving means that relatively moves the stage and the processing probe in XY directions in parallel to a surface of the sample and in a Z direction perpendicular to the surface of the sample; and
observation means that observes the surface of the sample.

5. A method of manufacturing a processing probe comprising a cantilever arranged in opposition to a sample, and a processing needle provided at a tip end of the cantilever to be able to contact with a surface of the sample in a state of being opposed to the sample, the processing needle being sharpened at a tip end thereof, the method comprising the steps of:
selecting a diamond small piece, which is sized to be conformed to a tip end dimension of the cantilever and has a projection, out of a plurality of diamond small pieces,
moving the selected diamond small piece onto a processing base after the selecting process; and
performing an etching processing in a manner to sharpen the projection of the diamond small piece in an optional shape with focused beam after the moving process and mounting a base end side of the projection to the tip end of the cantilever with the use of focused beam to fabricate the processing needle.

6. The method of manufacturing a processing probe according to claim 5, wherein the etching process is performed in a crystal orientation of diamond in the processing process.

7. The method of manufacturing a processing probe according to claim 6, wherein used as the diamond small piece is one, on a ground surface of which a crystal orientation of diamond can be observed.

8. The method of manufacturing a processing probe according to claim 5, further comprising a doping process of doping impurities in the diamond small piece after the moving process.

9. The method of manufacturing a processing probe, according to claim 5, wherein the diamond small piece possesses electroconductivity.

10. The method of manufacturing a processing probe according to claim 9, wherein the diamond small piece is a small piece of dopant containing synthetic diamond.
